(19) United States
(12) Patent Application Publication
(10) Pub. No.: US 2024/0199496 A1
(43) Pub. Date: Jun. 20, 2024

(54) ALPHA-SiAlON POROUS CERAMIC, AND PREPARATION METHOD AND USE THEREOF

(71) Applicant: Northwestern Polytechnical University, Xi'an City (CN)

(72) Inventors: Jie XU, Xi'an City (CN); Runwu YANG, Xi'an City (CN); Xuanyu MENG, Xi'an City (CN); Jia GUO, Xi'an City (CN); Mingyue WEI, Xi'an City (CN); Feng GAO, Xi'an City (CN)

(21) Appl. No.: 18/541,070

(22) Filed: Dec. 15, 2023

(30) Foreign Application Priority Data
Dec. 15, 2022 (CN) 202211615949.3

(51) Int. Cl. C04B 35/597; C04B 38/00; C04B 38/02

(52) U.S. Cl. CPC C04B 35/597; C04B 38/0054; C04B 38/02; C04B 2235/6567; C04B 2235/658; C04B 2235/77; C04B 2235/9607

(57) ABSTRACT

Provided are an α-SiAlON porous ceramic, and a preparation method and use thereof. The α-SiAlON porous ceramic has a dielectric constant of 1.19 to 3.21 at 12 GHz, a dielectric loss of 0.33×10⁻³ to 11.17×10⁻³, a thermal conductivity of 0.31 W/(m·K) to 0.81 W/(m·K) at room temperature, a thermal conductivity of 0.14 W/(m·K) to 0.59 W/(m·K) at a temperature of 1,500° C., and a bending strength of 72.4 MPa to 184.4 MPa.

### CROSS REFERENCE TO RELATED APPLICATION

This patent application claims the benefit and priority of Chinese Patent Application No. 202211615949.3 filed with the China National Intellectual Property Administration on Dec. 15, 2022, the disclosure of which is incorporated by reference herein in its entirety as part of the present application.

### TECHNICAL FIELD

The present disclosure relates to the technical field of porous ceramic materials, and in particular to an α-SiAlON porous ceramic, and a preparation method and use thereof.

### BACKGROUND

Radomes, as one of the core components for ultra-high-speed aircraft, need to have excellent wave transmission performance to allow accurate cruising, control and guidance, and can block external heat and thermal shocks to ensure the normal service of internal precision components. Currently, radome materials mostly have a sandwich, multilayer, or gradient structure, and the overall performance of radome materials is regulated by combining high-strength and high-dielectric constant materials with low-strength and low-dielectric constant materials. With the continuous improvement of a Mach number of modern aircraft, advanced requirements are put forward for wave transmission, heat insulation, and load-bearing properties of radome materials for aerospace, that is, the radome materials for aerospace need to have a dielectric constant of less than 5, a dielectric loss of less than 10-2, and a bending strength of higher than 50 MPa. Therefore, how to make radome materials for ultra-high-speed aircraft have properties such as high wave transmittance, low thermal conductivity, high strength, and light weight is the research focus and development direction of radome materials for ultra-high-speed aircraft.

As a group of Si—N-based ceramics, α-SiAlON ceramics have moderate dielectric properties, low thermal conductivity, and excellent mechanical properties. However, intrinsic morphologies of the α-SiAlON ceramics are presented as equiaxial grains, and the α-SiAlON ceramics exhibit poor bending resistance and fracture toughness, and wave transmittance difficult to meet service standards of radome materials. Currently, there are no patent reports for preparation of an α-SiAlON porous ceramic, and there are also no patent reports for use of the α-SiAlON ceramic as a high-temperature wave-transmitting material for a radome.

### SUMMARY

An object of the present disclosure is to provide an α-SiAlON porous ceramic, and a preparation method and use thereof. The α-SiAlON porous ceramic of the present disclosure has low dielectric constant, dielectric loss, and thermal conductivity, excellent wave transmission and heat insulation properties, and high bending strength, and shows an application prospect as a high-temperature wave-transmitting material for a radome.

To achieve the above object of the present disclosure, the present disclosure provides the following technical solutions.

The present disclosure provides an α-SiAlON porous ceramic, having a chemical formula of Y_{m/3}Si₍₁₂₋₍ₘ₊ₙ₎₎Al₍ₘ₊ₙ₎OₙN₍₁₆₋ₙ₎, with m being in a range of 1.2 to 2.0 and n being in a range of 1.0 to 1.5;

where the α-SiAlON porous ceramic has an average pore size of 1.64 μm to 2.97 μm; and long columnar grains are presented in the α-SiAlON porous ceramic.

In some embodiments, the α-SiAlON porous ceramic has a porosity of 45% to 75% and a density of 0.83 g/cm³ to 1.82 g/cm³.

In some embodiments, the long columnar grains have an average diameter of 1 μm to 2 μm and an average aspect ratio of 2 to 4.

In some embodiments, the α-SiAlON porous ceramic has a dielectric constant of 1.19 to 3.21 at 12 GHz, a dielectric loss of 0.33×10⁻³ to 11.17×10⁻³, a thermal conductivity of 0.31 W/(m·K) to 0.81 W/(m·K) at room temperature, a thermal conductivity of 0.14 W/(m·K) to 0.59 W/(m·K) at a temperature of 1,500° C., and a bending strength of 72.4 MPa to 184.4 MPa.

The present disclosure provides a method for preparing the α-SiAlON porous ceramic described in the above solutions, including the following steps:
mixing and ball-milling an α-SiAlON ceramic powder, an epoxy resin, and ethanol to obtain an α-SiAlON ceramic slurry, the α-SiAlON ceramic powder and the α-SiAlON porous ceramic having the same chemical composition;
subjecting the α-SiAlON ceramic slurry to vacuum defoaming to obtain a defoamed slurry, and mixing the defoamed slurry with polyamide (PA) to obtain a mixture;
injecting the mixture into a mold, curing, and drying to remove the ethanol to obtain an α-SiAlON porous ceramic rough-body; and
subjecting the α-SiAlON porous ceramic rough-body to debinding and sintering sequentially to obtain the α-SiAlON porous ceramic.

In some embodiments, a mass ratio of the α-SiAlON ceramic powder, the ethanol, and the epoxy resin is in a range of (5-10):20:(2-4); and a mass ratio of the PA to the epoxy resin is in a range of (1-4):10.

In some embodiments, the curing is conducted at a temperature of 50° C. to 80° C. for 5 min to 10 min.

In some embodiments, the debinding includes: heating to a temperature of 280° C. and holding at the temperature for 2 h to 5 h; further heating to a temperature of 450° C. and holding at the temperature for 2 h to 5 h; and further heating to a temperature of 520° C. and holding at the temperature for 2 h to 5 h.

In some embodiments, the sintering is conducted at a temperature of 1,750° C. to 1,850° C. for 1 h to 3 h in a nitrogen atmosphere.

The present disclosure provides use of the α-SiAlON porous ceramic described in the above solutions or the α-SiAlON porous ceramic prepared by the method described in the above solutions in a high-temperature wave-transmitting material for a radome.

The present disclosure provides an α-SiAlON porous ceramic, having a chemical formula of Y_{m/3}Si₍₁₂₋₍ₘ₊ₙ₎₎Al₍ₘ₊ₙ₎OₙN₍₁₆₋ₙ₎, with m being in a range of 1.2 to 2.0 and n being in a range of 1.0 to 1.5; where the α-SiAlON porous ceramic has an average pore size of 1.64 μm to 2.97 μm; and long columnar grains are presented in the α-SiAlON porous ceramic.

In the present disclosure, a high solid solubility is selected, that is, values of m and n are high, which could effectively promote the growth of α-SiAlON with a hexagonal structure in a c-axis direction and is conducive to promoting the generation of long columnar grains. In the present disclosure, long columnar grains are successfully introduced into the α-SiAlON porous ceramic, so that self-enhancement of the α-SiAlON porous ceramic is realized by mechanisms such as crack bridging, deflection and grain pulling, thereby improving the bending strength of the α-SiAlON porous ceramic.

In the present disclosure, the high solid solubility is selected, that is, values of m and n are high, allowing obtaining the α-SiAlON porous ceramic with bond substitution and more Y³⁺ doping in unit cell voids. Doped Y³⁺ as an additionally introduced phonon scattering center could effectively improve the phonon scattering efficiency of the material and reduce the intrinsic thermal conductivity of the material. In addition, in the present disclosure, a micro-scale pore structure is introduced into the α-SiAlON ceramic and a gas phase is used as a second phase, so that the thermal conductivity of the material is effectively reduced; and a micro-scale scattering system is constructed to effectively scatter thermal radiation micron waves at a high temperature, and improve the heat insulation performance of the material at a high temperature. The introduction of the gas phase also significantly reduces the dielectric constant and dielectric loss of the α-SiAlON porous ceramic, and improves the wave transmission performance of the α-SiAlON porous ceramic.

The α-SiAlON porous ceramic provided by the present disclosure has a dielectric constant of 1.19 to 3.21 at 12 GHz, a dielectric loss of 0.33×10⁻³ to 11.17×10⁻³, a thermal conductivity of 0.31 W/(m·K) to 0.81 W/(m·K) at room temperature, a thermal conductivity of 0.14 W/(m·K) to 0.59 W/(m·K) at a temperature of 1,500° C., and the bending strength of 72.4 MPa to 184.4 MPa, which meets the requirements of integration of wave transmission, heat insulation, and load-bearing functions. Thus, the α-SiAlON porous ceramic shows an application prospect as the high-temperature wave-transmitting material for the radome.

The present disclosure provides a method for preparing the α-SiAlON porous ceramic described in the above solutions. In the present disclosure, an α-SiAlON ceramic powder is cured in situ by an eco-friendly low-toxicity epoxy resin-based gel injection molding method based on a cross-linking curing effect between an epoxy resin and PA. The method could complete the curing and demolding of the ceramic powder in a short time, and could effectively avoid the sedimentation of the ceramic powder in a slurry. In the preparation method, a porous skeleton structure could be retained after debinding, and then sintering could be conducted to obtain the α-SiAlON porous ceramic with connected micro-scale porous structures.

### BRIEF DESCRIPTION OF THE DRAWINGS

FIG. 1 shows an X-ray diffraction (XRD) pattern of the α-SiAlON porous ceramic prepared according to Example 1;

FIGS. 2A-2B show scanning electron microscopy (SEM) images of the α-SiAlON porous ceramic rough-body without debinding prepared according to Example 2; and

FIGS. 3A-3B show SEM images of the α-SiAlON porous ceramic obtained after sintering according to Example 2.

### DETAILED DESCRIPTION OF THE EMBODIMENTS

The present disclosure provides an α-SiAlON porous ceramic, having a chemical formula of Y_{m/3}Si₍₁₂₋₍ₘ₊ₙ₎₎Al₍ₘ₊ₙ₎OₙN₍₁₆₋ₙ₎, with m being in a range of 1.2 to 2.0 and n being in a range of 1.0 to 1.5;

where the α-SiAlON porous ceramic has an average pore size of 1.64 μm to 2.97 μm; and long columnar grains are presented in the α-SiAlON porous ceramic.

In some embodiments of the present disclosure, the α-SiAlON porous ceramic has a porosity of 45% to 75% and a density of 0.83 g/cm³ to 1.82 g/cm³.

In some embodiments of the present disclosure, the long columnar grains have an average diameter of 1 μm to 2 μm and an average aspect ratio of 2 to 4.

In the present disclosure, the α-SiAlON porous ceramic has a dielectric constant of 1.19 to 3.21 at 12 GHz, a dielectric loss of 0.33×10⁻³ to 11.17×10⁻³, a thermal conductivity of 0.31 W/(m·K) to 0.81 W/(m·K) at room temperature, a thermal conductivity of 0.14 W/(m·K) to 0.59 W/(m·K) at a temperature of 1,500° C., and a bending strength of 72.4 MPa to 184.4 MPa, which meets the requirements of integration of wave transmission, heat insulation, and load-bearing functions, and shows an application prospect as a high-temperature wave-transmitting material for a radome.

The present disclosure provides a method for preparing the α-SiAlON porous ceramic described in the above solutions, including the following steps:
mixing and ball-milling an α-SiAlON ceramic powder, an epoxy resin, and ethanol to obtain an α-SiAlON ceramic slurry, the α-SiAlON ceramic powder and the α-SiAlON porous ceramic having the same chemical composition;
subjecting the α-SiAlON ceramic slurry to vacuum defoaming to obtain a defoamed slurry, and mixing the defoamed slurry with PA to obtain a mixture;
injecting the mixture into a mold, curing, and drying to remove the ethanol to obtain an α-SiAlON porous ceramic rough-body; and
subjecting the α-SiAlON porous ceramic rough-body to debinding and sintering sequentially to obtain the α-SiAlON porous ceramic.

The raw materials used in the present disclosure are commercially-available products well known in the art, unless otherwise specified.

In the present disclosure, an α-SiAlON ceramic powder, an epoxy resin, and ethanol are mixed and ball-milled to obtain an α-SiAlON ceramic slurry.

In the present disclosure, the α-SiAlON ceramic powder is prepared by a method well known in the art, and could be specifically prepared through the following steps: according to a chemical formula of the desired α-SiAlON ceramic powder, yttrium oxide, aluminum nitride, silicon nitride, and alumina raw material powders are weighed according to a specified chemical mass ratio; and ethanol is added thereto, and then mixed and ball-milled to obtain a system. The system is dried to remove the ethanol, and then calcined at a high temperature in a nitrogen atmosphere to obtain the α-SiAlON ceramic powder with a corresponding composition.

The present disclosure has no special requirements for a particle size of the α-SiAlON ceramic powder, and the particle size well known in the art may be adopted. In some embodiments of the present disclosure, the α-SiAlON ceramic powder has an average particle size of 1.07 μm.

In some embodiments of the present disclosure, a mass ratio of the α-SiAlON ceramic powder, the ethanol, and the epoxy resin is in a range of (5-10):20:(2-4), and preferably in a range of (6-8):20:(2-4).

The present disclosure has no special requirements for conditions of the mixing and ball-milling, as long as the raw materials could be evenly mixed. In an embodiment of the present disclosure, the ball-milling is conducted at a rotational speed of 300 r/min for 3 h; and a mass ratio of silicon nitride mill balls to the α-SiAlON ceramic powder is 1:1.

In the present disclosure, after an α-SiAlON ceramic slurry is obtained, the α-SiAlON ceramic slurry is subjected to vacuum defoaming, and then mixed with PA to obtain a mixture.

The present disclosure has no special requirements for a process of the vacuum defoaming, and a vacuum defoaming process well known in the art may be adopted.

In some embodiments of the present disclosure, a mass ratio of the PA to the epoxy resin is in a range of (1-4):10, preferably in a range of (1.5-3.5):10, and more preferably in a range of (2-3):10. In the present disclosure, the PA is added to serve as a curing agent for the epoxy resin.

In some embodiments of the present disclosure, mixing a defoamed slurry with the PA includes: adding the PA into the degassed slurry under magnetic stirring. In an embodiment of the present disclosure, the magnetic stirring is conducted at a rotational speed of 350 r/min for 3 min.

In the present disclosure, after the mixture is obtained, the mixture is injected into a mold, cured, and dried to remove the ethanol to obtain an α-SiAlON porous ceramic rough-body.

In some embodiments of the present disclosure, the curing is conducted at a temperature of 50° C. to 80° C., and preferably 60° C. to 70° C. In some embodiments of the present disclosure, the curing is conducted for 5 min to 10 min, and preferably 6 min to 8 min.

In some embodiments of the present disclosure, the drying is conducted at a temperature of 60ºC for 24 h.

In the present disclosure, after the α-SiAlON porous ceramic rough-body is obtained, the α-SiAlON porous ceramic rough-body is subjected to debinding and sintering sequentially to obtain the α-SiAlON porous ceramic.

In some embodiments of the present disclosure, the debinding includes: heating to a temperature of 280° C. and holding at the temperature for 2 h to 5 h; further heating to a temperature of 450° C. and holding at the temperature for 2 h to 5 h; and further heating to a temperature of 520° C. and holding at the temperature for 2 h to 5 h. The present disclosure has no special requirements for a heating rate during the debinding, and a heating rate well known in the art may be adopted. In the present disclosure, the epoxy resin and the PA are removed by the debinding.

In some embodiments of the present disclosure, the sintering is conducted at a temperature of 1,750° C. to 1,850° C. and preferably 1,770° C. to 1,820° C. In some embodiments of the present disclosure, the sintering is conducted for 1 h to 3 h and preferably 1.5 h to 2.5 h. In some embodiments of the present disclosure, the sintering is conducted in a nitrogen atmosphere. After the debinding, the binding among powder is very fragile, and a system obtained by debinding is not a porous ceramic. The sintering makes powder particles merge and grow under a drive of a high temperature to produce a strong binding force, such that the porous ceramic could be obtained.

The present disclosure provides use of the α-SiAlON porous ceramic described in the above solutions or the α-SiAlON porous ceramic prepared by the method described in the above solutions in a high-temperature wave-transmitting material for a radome.

The α-SiAlON porous ceramic and the preparation method thereof provided by the present disclosure will be described in detail below in conjunction with examples, but these examples should not be understood as limiting the scope of the present disclosure.

In the following examples, the α-SiAlON ceramic powder used has an average particle size of 1.07 μm; according to a chemical formula of the desired α-SiAlON ceramic powder, yttrium oxide, aluminum nitride, silicon nitride, and alumina raw material powders are weighed according to a specified chemical mass ratio; and ethanol is added thereto, and then mixed by ball milling for 24 h to obtain a system. The system is dried to remove the ethanol, and then calcined at a temperature of 1,650° C. for 1 h in a nitrogen atmosphere to obtain the α-SiAlON ceramic powder with a corresponding composition; and unless otherwise specified, other reagents and materials are commercially available.

### Examples 1 to 9

A scheme for preparing an α-SiAlON porous ceramic was as follows:

Step (1): An α-SiAlON ceramic powder and an epoxy resin were weighed according to specified proportions and added into a ball-milling tank, and ethanol was added thereto, and the resulting system was subjected to mixing and ball-milling to obtain an α-SiAlON ceramic slurry. The ball-milling was conducted at a rotational speed of 300 r/min for 3 h. A mass ratio of silicon nitride mill balls to the α-SiAlON ceramic powder was 1:1. The α-SiAlON ceramic powder had a chemical formula of Y_{m/3}Si₍₁₂₋₍ₘ₊ₙ₎₎Al₍ₘ₊ₙ₎OₙN₍₁₆₋ₙ₎, with m being 1.2 to 2.0 and n being 1.0 to 1.5. A mass ratio of the α-SiAlON ceramic powder, the ethanol, and the epoxy resin was in a range of (5-10):20:(2-4). Schemes of step (1) in Examples 1 to 9 are shown in Table 1 below.

TABLE 1
Schemes of step (1) in Examples 1 to 9

| | Examples | | | | | | | | |
|---|---|---|---|---|---|---|---|---|---|
| Material | 1 | 2 | 3 | 4 | 5 | 6 | 7 | 8 | 9 |
| Composition | m = 1.2 | m = 1.3 | m = 1.5 | m = 1.5 | m = 1.5 | m = 1.7 | m = 1.7 | m = 1.7 | m = 2.0 |
| of | n = 1.5 | n = 1.5 | n = 1.0 | n = 1.2 | n = 1.5 | n = 1.0 | n = 1.2 | n = 1.5 | n = 1.5 |
| α-SiAlON | | | | | | | | | |
| ceramic | | | | | | | | | |
| powder | | | | | | | | | |
| α-SiAlON | 50 | 50 | 50 | 70 | 100 | 50 | 70 | 100 | 100 |
| ceramic | | | | | | | | | |
| powder, g | | | | | | | | | |
| Epoxy resin, | 20 | 35 | 40 | 30 | 20 | 40 | 30 | 20 | 20 |
| g | | | | | | | | | |
| Ethanol, g | 200 | 200 | 200 | 200 | 200 | 200 | 200 | 200 | 200 |

Step (2): The α-SiAlON ceramic slurry obtained in step (1) was subjected to vacuum defoaming to obtain a defoamed slurry. PA was added into the defoamed slurry according to a specified proportion, and then mechanically stirred at 350 r/min for 3 min to obtain a mixture. The mixture was injected into a mold, and then allowed to stand in a constant-temperature and constant-humidity incubator for curing. A mass ratio of the PA to the epoxy resin was in a range of (1-4):10 and the curing was conducted at a temperature of 50° C. to 80° C. for 5 min to 10 min. A cured rough-body was demolded and dried at a temperature of 60° C. for 24 h in an oven to remove the ethanol to obtain an α-SiAlON porous ceramic rough-body. Schemes of step (2) in Examples 1 to 9 are shown in Table 2 below.

TABLE 2
Schemes of step (2) in Examples 1 to 9

| Component/process | Examples | | | | | | | | |
|---|---|---|---|---|---|---|---|---|---|
| parameters | 1 | 2 | 3 | 4 | 5 | 6 | 7 | 8 | 9 |
| PA, g | 4 | 7 | 16 | 6 | 2 | 12 | 6 | 2 | 2 |
| Curing temperature, ° C. | 60 | 60 | 50 | 60 | 80 | 60 | 70 | 80 | 80 |
| Curing time, min | 10 | 7 | 5 | 6 | 8 | 5 | 6 | 10 | 10 |

Step (3): The α-SiAlON porous ceramic body obtained in step (2) was subjected to debinding at 520° C., and temperature-holding platforms were set at a temperature of 280° C., 450° C., and 520° C. and a temperature-holding time was set as 2 h to 5 h. Schemes of step (3) in Examples 1 to 9 are shown in Table 3 below.

TABLE 3
Schemes of step (3) in Examples 1 to 9

| | Examples | | | | | | | | |
|---|---|---|---|---|---|---|---|---|---|
| Process parameter | 1 | 2 | 3 | 4 | 5 | 6 | 7 | 8 | 9 |
| Temperature-holding | 5 | 4 | 5 | 3 | 2 | 5 | 5 | 2 | 2 |
| time, g | | | | | | | | | |

Step (4): The α-SiAlON porous ceramic body obtained after the debinding in step (3) was sintered at a temperature of 1,750° C. to 1,850° C. for 1 h to 3 h in a flowing nitrogen atmosphere to obtain an α-SiAlON porous ceramic. Schemes of step (4) in Examples 1 to 9 are shown in Table 4 below.

TABLE 4
Schemes of step (4) in Examples 1 to 9

| | Examples | | | | | | | | |
|---|---|---|---|---|---|---|---|---|---|
| Process parameters | 1 | 2 | 3 | 4 | 5 | 6 | 7 | 8 | 9 |
| Sintering | 1700 | 1750 | 1850 | 1800 | 1750 | 1750 | 1850 | 1800 | 1850 |
| temperature, ° C. | | | | | | | | | |
| Sintering time, h | 1 | 2 | 1 | 2 | 3 | 2 | 1 | 2 | 3 |

### Structure and Performance Characterization.

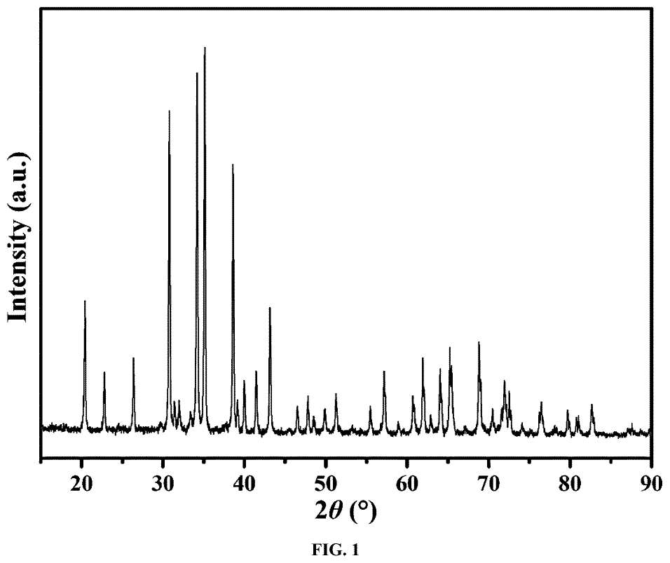

FIG. 1 shows an XRD pattern of the α-SiAlON porous ceramic prepared according to Example 1. It can be seen from FIG. 1 that a main phase of the α-SiAlON porous ceramic is reflected by a diffraction peak of a α-SiAlON hexagonal crystal system.

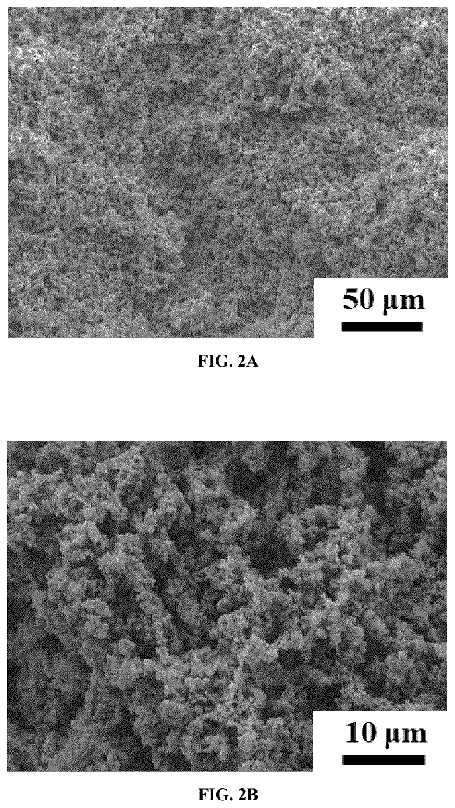

FIGS. 2A-2B show SEM images of the α-SiAlON porous ceramic rough-body without debinding prepared according to Example 2, wherein FIG. 2A and FIG. 2B are SEM images at different magnifications, respectively. It can be seen from FIGS. 2A-2B that, after the ethanol is removed by the drying, powder particles bind to each other through a gel network formed after curing of the epoxy resin and PA, and are loosely stacked to form a three-dimensional (3D) skeleton structure with an uniform component and structure distribution, indicating the advantages of this process in preparation of the α-SiAlON porous ceramic.

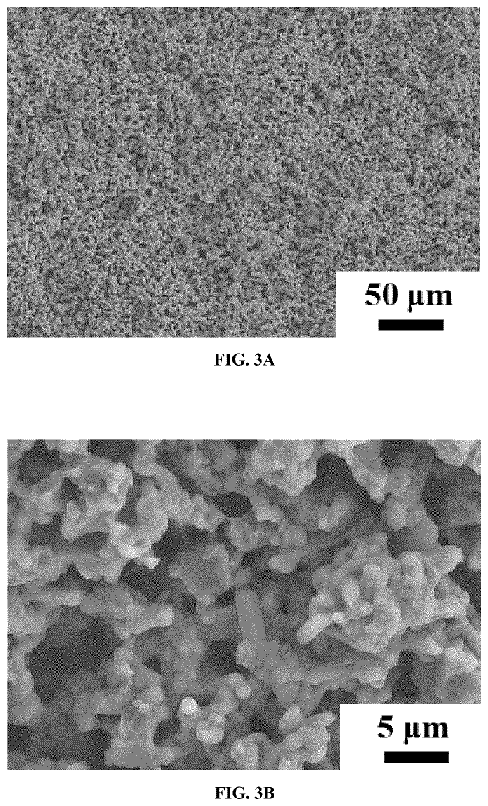

FIGS. 3A-3B show SEM images of the α-SiAlON porous ceramic obtained after sintering according to Example 2, wherein the left and right panels show SEM images at different magnifications, respectively. It can be seen from FIGS. 3A-3B show that the α-SiAlON porous ceramic obtained after the sintering has connected micro-scale porous structures and excellent inter-grain binding, and the α-SiAlON porous ceramic obviously has some long columnar grains.

Other specific properties are as follows.

The α-SiAlON porous ceramic prepared according to Example 1 has a porosity of 75%, a density of 0.83 g/cm³, an average pore size of 2.97 μm, a dielectric constant of 1.19 at 12 GHZ, a dielectric loss of 0.33×10⁻³, a thermal conductivity of 0.31 W/(m·K) at room temperature, a thermal conductivity of 0.14 W/(m·K) at a high temperature (1,500° C.), and a bending strength of 72.4 MPa. In the α-SiAlON porous ceramic, long columnar grains with an average diameter of 1 μm and an average aspect ratio of 2 are successfully introduced. The properties of the α-SiAlON porous ceramic could meet the requirements of high-temperature wave-transmitting materials for radomes.

The α-SiAlON porous ceramic prepared according to Example 2 has a porosity of 65%, a density of 1.16 g/cm³, an average pore size of 2.89 μm, a dielectric constant of 1.28 at 12 GHZ, a dielectric loss of 0.35×10⁻³, a thermal conductivity of 0.36 W/(m·K) at room temperature, a thermal conductivity of 0.18 W/(m·K) at a high temperature (1,500° C.), and a bending strength of 88.3 MPa. In the α-SiAlON porous ceramic, long columnar grains with an average diameter of 1 μm and an average aspect ratio of 2 are successfully introduced. The properties of the α-SiAlON porous ceramic could meet the requirements of high-temperature wave-transmitting materials for radomes.

The α-SiAlON porous ceramic prepared according to Example 3 has a porosity of 60%, a density of 1.32 g/cm³, an average pore size of 2.54 μm, a dielectric constant of 1.54 at 12 GHz, a dielectric loss of 0.47×10⁻³, a thermal conductivity of 0.41 W/(m·K) at room temperature, a thermal conductivity of 0.27 W/(m·K) at a high temperature (1,500° C.), and a bending strength of 104.5 MPa. In the α-SiAlON porous ceramic, long columnar grains with an average diameter of 2 μm and an average aspect ratio of 4 are successfully introduced. The properties of the α-SiAlON porous ceramic could meet the requirements of high-temperature wave-transmitting materials for radomes.

The α-SiAlON porous ceramic prepared according to Example 4 has a porosity of 58%, a density of 1.39 g/cm³, an average pore size of 2.41 μm, a dielectric constant of 1.76 at 12 GHz, a dielectric loss of 0.61×10⁻³, a thermal conductivity of 0.53 W/(m·K) at room temperature, a thermal conductivity of 0.31 W/(m·K) at a high temperature (1,500° C.), and a bending strength of 120.1 MPa. In the α-SiAlON porous ceramic, long columnar grains with an average diameter of 1.7 μm and an average aspect ratio of 1.5 are successfully introduced. The properties of the α-SiAlON porous ceramic could meet the requirements of high-temperature wave-transmitting materials for radomes.

The α-SiAlON porous ceramic prepared according to Example 5 has a porosity of 63%, a density of 1.22 g/cm³, an average pore size of 2.65 μm, a dielectric constant of 1.38 at 12 GHZ, a dielectric loss of 0.39×10⁻³, a thermal conductivity of 0.36 W/(m·K) at room temperature, a thermal conductivity of 0.22 W/(m·K) at a high temperature (1,500° C.), and a bending strength of 95.7 MPa. In the α-SiAlON porous ceramic, long columnar grains with an average diameter of 1.2 μm and an average aspect ratio of 3.5 are successfully introduced. The properties of the α-SiAlON porous ceramic could meet the requirements of high-temperature wave-transmitting materials for radomes.

The α-SiAlON porous ceramic prepared according to Example 6 has a porosity of 61%, a density of 1.29 g/cm³, an average pore size of 2.57 μm, a dielectric constant of 1.46 at 12 GHZ, a dielectric loss of 0.43×10⁻³, a thermal conductivity of 0.40 W/(m·K) at room temperature, a thermal conductivity of 0.26 W/(m·K) at a high temperature (1,500° C.), and a bending strength of 100.4 MPa. In the α-SiAlON porous ceramic, long columnar grains with an average diameter of 1.9 μm and an average aspect ratio of 3 are successfully introduced. The properties of the α-SiAlON porous ceramic could meet the requirements of high-temperature wave-transmitting materials for radomes.

The α-SiAlON porous ceramic prepared according to Example 7 has a porosity of 54%, a density of 1.52 g/cm³, an average pore size of 1.99 μm, a dielectric constant of 2.45 at 12 GHZ, a dielectric loss of 0.87×10⁻³, a thermal conductivity of 0.63 W/(m·K) at room temperature, a thermal conductivity of 0.44 W/(m·K) at a high temperature (1,500° C.), and a bending strength of 143.3 MPa. In the α-SiAlON porous ceramic, long columnar grains with an average diameter of 2 μm and an average aspect ratio of 3.6 are successfully introduced. The properties of the α-SiAlON porous ceramic could meet the requirements of high-temperature wave-transmitting materials for radomes.

The α-SiAlON porous ceramic prepared according to Example 8 has a porosity of 52%, a density of 1.58 g/cm³, an average pore size of 1.87 μm, a dielectric constant of 3.17 at 12 GHZ, a dielectric loss of 1.12×10⁻³, a thermal conductivity of 0.77 W/(m·K) at room temperature, a thermal conductivity of 0.54 W/(m·K) at a high temperature (1,500° C.), and a bending strength of 152.5 MPa. In the α-SiAlON porous ceramic, long columnar grains with an average diameter of 2 μm and an average aspect ratio of 4 are successfully introduced. The properties of the α-SiAlON porous ceramic could meet the requirements of high-temperature wave-transmitting materials for radomes.

The α-SiAlON porous ceramic prepared according to Example 9 has a porosity of 45%, a density of 1.82 g/cm³, an average pore size of 1.64 μm, a dielectric constant of 3.21 at 12 GHz, a dielectric loss of 1.17×10⁻³, a thermal conductivity of 0.81 W/(m·K) at room temperature, a thermal conductivity of 0.59 W/(m·K) at a high temperature (1,500° C.), and a bending strength of 184.4 MPa. In the α-SiAlON porous ceramic, long columnar grains with an average diameter of 2 μm and an average aspect ratio of 3 are successfully introduced. The properties of the α-SiAlON porous ceramic could meet the requirements of high-temperature wave-transmitting materials for radomes.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

1. An α-SiAlON porous ceramic, having a chemical formula of Y_{m/3}Si₍₁₂₋₍ₘ₊ₙ₎Al₍ₘ₊ₙ₎OₙN₍₁₆₋ₙ₎, with m being in a range of 1.2 to 2.0 and n being in a range of 1.0 to 1.5;
wherein the α-SiAlON porous ceramic has an average pore size of 1.64 μm to 2.97 μm, and long columnar grains are presented in the α-SiAlON porous ceramic.

2. The α-SiAlON porous ceramic of claim 1, wherein the α-SiAlON porous ceramic has a porosity of 45% to 75% and a density of 0.83 g/cm³ to 1.82 g/cm³.

3. The α-SiAlON porous ceramic of claim 1, wherein the long columnar grains have an average diameter of 1 μm to 2 μm and an average aspect ratio of 2 to 4.

4. The α-SiAlON porous ceramic of claim 1, wherein the α-SiAlON porous ceramic has a dielectric constant of 1.19 to 3.21 at 12 GHz, a dielectric loss of 0.33×10⁻³ to 11.17×10⁻³, a thermal conductivity of 0.31 W/(m·K) to 0.81 W/(m·K) at room temperature, a thermal conductivity of 0.14 W/(m·K) to 0.59 W/(m·K) at a temperature of 1,500° C., and a bending strength of 72.4 MPa to 184.4 MPa.

5. A method for preparing the α-SiAlON porous ceramic of claim 1, comprising the following steps:
mixing and ball-milling an α-SiAlON ceramic powder, an epoxy resin, and ethanol to obtain an α-SiAlON ceramic slurry, the α-SiAlON ceramic powder and the α-SiAlON porous ceramic having the same chemical composition;
subjecting the α-SiAlON ceramic slurry to vacuum defoaming to obtain a defoamed slurry, and mixing the defoamed slurry with polyamide (PA) to obtain a mixture;
injecting the mixture into a mold, curing, and drying to remove the ethanol to obtain an α-SiAlON porous ceramic rough-body; and
subjecting the α-SiAlON porous ceramic rough-body to debinding and sintering sequentially to obtain the α-SiAlON porous ceramic.

6. The method of claim 5, wherein a mass ratio of the α-SiAlON ceramic powder, the ethanol, and the epoxy resin is in a range of (5-10):20:(2-4); and a mass ratio of the PA to the epoxy resin is in a range of (1-4):10.

7. The method of claim 5, wherein the curing is conducted at a temperature of 50° C. to 80° C. for 5 min to 10 min.

8. The method of claim 5, wherein the debinding comprises: heating to a temperature of 280° C. and holding at the temperature for 2 h to 5 h; further heating to a temperature of 450° C. and holding at the temperature for 2 h to 5 h; and further heating to a temperature of 520° C. and holding at the temperature for 2 h to 5 h.

9. The method of claim 5, wherein the sintering is conducted at a temperature of 1,750° C. to 1,850° C. for 1 h to 3 h in a nitrogen atmosphere.

10. A method for using the α-SiAlON porous ceramic of claim 1, comprising using the α-SiAlON porous ceramic as a high-temperature wave-transmitting material for a radome.

11. The method of claim 5, wherein the α-SiAlON porous ceramic has a porosity of 45% to 75% and a density of 0.83 g/cm³ to 1.82 g/cm³.

12. The method of claim 5, wherein the long columnar grains have an average diameter of 1 μm to 2 μm and an average aspect ratio of 2 to 4.

13. The method of claim 5, wherein the α-SiAlON porous ceramic has a dielectric constant of 1.19 to 3.21 at 12 GHz, a dielectric loss of 0.33×10⁻³ to 11.17×10⁻³, a thermal conductivity of 0.31 W/(m·K) to 0.81 W/(m·K) at room temperature, a thermal conductivity of 0.14 W/(m·K) to 0.59 W/(m·K) at a temperature of 1,500° C., and a bending strength of 72.4 MPa to 184.4 MPa.

14. The method of claim 10, wherein the α-SiAlON porous ceramic has a porosity of 45% to 75% and a density of 0.83 g/cm³ to 1.82 g/cm³.

15. The method of claim 10, wherein the long columnar grains have an average diameter of 1 μm to 2 μm and an average aspect ratio of 2 to 4.

16. The method of claim 10, wherein the α-SiAlON porous ceramic has a dielectric constant of 1.19 to 3.21 at 12 GHz, a dielectric loss of 0.33×10⁻³ to 11.17×10⁻³, a thermal conductivity of 0.31 W/(m·K) to 0.81 W/(m·K) at room temperature, a thermal conductivity of 0.14 W/(m·K) to 0.59 W/(m·K) at a temperature of 1,500° C., and a bending strength of 72.4 MPa to 184.4 MPa.
